(19) United States
(12) Patent Application Publication
(10) Pub. No.: US 2015/0081469 A1
(43) Pub. Date: Mar. 19, 2015

(54) ASSISTING BUYING DECISIONS USING CUSTOMER BEHAVIOR ANALYSIS

(71) Applicant: International Business Machines Corporation, Armonk, NY (US)

(72) Inventors: AJOY ACHARYYA, Kolkata (IN); Ajay Kumar Behuria, Bentonville, AR (US); James Edward Bostick, Cedar Park, TX (US); John Michael Ganci, JR., Cary, NC (US); Tanambam Debasis Sinha, Kolkata (IN); Swetank S. Sisodia, Kolkata (IN); Craig Matthew Trim, Sylmar, CA (US); David Scott Wenk, Byron Center, MI (US)

(73) Assignee: International Business Machines Corporation, Armonk, NY (US)

(21) Appl. No.: 14/028,900

(22) Filed: Sep. 17, 2013

(51) Int. Cl. G06Q 30/06

(52) U.S. Cl. CPC G06Q 30/0631
USPC 705/26.7

(57) ABSTRACT

A method, system, and computer program product for assisting buying decisions using customer behavior analysis are provided in the illustrative embodiments. Product information comprising a set of product attributes is received about a grouping of products. Customer behavior information about a behavior of a customer is received from which a set of customer buying behavior factors is extracted. A customer buying behavior factor comprises an inferred preference of the customer for buying a product from the grouping of products. A weight is assigned to a customer buying behavior factor. A set of weighted customer buying behavior factors is mapped to a subset of the product attributes. At least one product is selected from the grouping of products such that the at least one product includes a subset of product attributes, and an overall weighted score of the at least one product exceeds a threshold.

### TECHNICAL FIELD

The present invention relates generally to a method, system, and computer program product for improving customer-experience in retailing. More particularly, the present invention relates to a method, system, and computer program product for assisting buying decisions using customer behavior analysis.

### BACKGROUND

A customer is an individual contemplating the purchase of a retailed item. From the customer's point of view the buying process involves a series of decisions.

This decision making process applies not only to buying experiences in brick and mortar retail locations but also when buying from an online retailer. Furthermore, this decision making process applies to buying any of a vast variety of items, which include goods, such as things for everyday use and durable goods, and even services.

### SUMMARY

The illustrative embodiments provide a method, system, and computer program product for assisting buying decisions using customer behavior analysis. An embodiment receives, forming product information, information about a grouping of products, wherein the product information comprises a set of product attributes. The embodiment receives, forming customer behavior information, information about a behavior of a customer. The embodiment extracts, using a processor and a memory, from the customer behavior information, a set of customer buying behavior factors, wherein a customer buying behavior factor in the set of customer buying behavior factors comprises an inferred preference of the customer for buying a product from the grouping of products. The embodiment assigns, a weight to a customer buying behavior factor in the set of customer buying behavior factors, wherein the weight is a member of a set of weights corresponding to the set of customer buying behavior factors, forming a set of weighted customer buying behavior factors. The embodiment maps the set of weighted customer buying behavior factors to a subset of the product attributes. The embodiment selects at least one product from the grouping of products such that the at least one product includes a subset of product attributes, and wherein an overall weighted score of the at least one product exceeds a threshold.

Another embodiment comprises one or more computer-readable tangible storage devices. The embodiment further comprises program instructions, stored on at least one of the one or more storage devices, to receive, forming product information, information about a grouping of products, wherein the product information comprises a set of product attributes. The embodiment further comprises program instructions, stored on at least one of the one or more storage devices, to receive, forming customer behavior information, information about a behavior of a customer. The embodiment further comprises program instructions, stored on at least one of the one or more storage devices, to extract, using a processor and a memory, from the customer behavior information, a set of customer buying behavior factors, wherein a customer buying behavior factor in the set of customer buying behavior factors comprises an inferred preference of the customer for buying a product from the grouping of products. The embodiment further comprises program instructions, stored on at least one of the one or more storage devices, to assign, a weight to a customer buying behavior factor in the set of customer buying behavior factors, wherein the weight is a member of a set of weights corresponding to the set of customer buying behavior factors, forming a set of weighted customer buying behavior factors. The embodiment further comprises program instructions, stored on at least one of the one or more storage devices, to map the set of weighted customer buying behavior factors to a subset of the product attributes. The embodiment further comprises program instructions, stored on at least one of the one or more storage devices, to select at least one product from the grouping of products such that the at least one product includes a subset of product attributes, and wherein an overall weighted score of the at least one product exceeds a threshold.

Another embodiment comprises one or more processors, one or more computer-readable memories and one or more computer-readable tangible storage devices. The embodiment further comprises program instructions, stored on at least one of the one or more storage devices for execution by at least one of the one or more processors via at least one of the one or more memories, to receive, forming product information, information about a grouping of products, wherein the product information comprises a set of product attributes. The embodiment further comprises program instructions, stored on at least one of the one or more storage devices for execution by at least one of the one or more processors via at least one of the one or more memories, to receive, forming customer behavior information, information about a behavior of a customer. The embodiment further comprises program instructions, stored on at least one of the one or more storage devices for execution by at least one of the one or more processors via at least one of the one or more memories, to extract, using a processor and a memory, from the customer behavior information, a set of customer buying behavior factors, wherein a customer buying behavior factor in the set of customer buying behavior factors comprises an inferred preference of the customer for buying a product from the grouping of products. The embodiment further comprises program instructions, stored on at least one of the one or more storage devices for execution by at least one of the one or more processors via at least one of the one or more memories, to assign, a weight to a customer buying behavior factor in the set of customer buying behavior factors, wherein the weight is a member of a set of weights corresponding to the set of customer buying behavior factors, forming a set of weighted customer buying behavior factors. The embodiment further comprises program instructions, stored on at least one of the one or more storage devices for execution by at least one of the one or more processors via at least one of the one or more memories, to map the set of weighted customer buying behavior factors to a subset of the product attributes. The embodiment further comprises program instructions, stored on at least one of the one or more storage devices for execution by at least one of the one or more processors via at least one of the one or more memories, to select at least one product from the grouping of products such that the at least one product includes a subset of product attributes, and wherein an overall weighted score of the at least one product exceeds a threshold.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a process of correlating product information with customer behavior information in accordance with an illustrative embodiment;

FIG. 4 depicts a block diagram of an example process of correlating product attributes with customer buying behavior factors for assisting buying decisions using customer behavior analysis in accordance with an illustrative embodiment;

FIG. 5 depicts a block diagram of an example configuration of an analytics engine in accordance with an illustrative embodiment;

FIG. 6 depicts a graph chart of extracting customer buying behavior factors from customer behavior information for assisting buying decisions using customer behavior analysis in accordance with an illustrative embodiment;

FIG. 7 depicts a flowchart of an example process for assisting buying decisions using customer behavior analysis in accordance with an illustrative embodiment; and

FIG. 8 depicts an example report generated using an example process for assisting buying decisions using customer behavior analysis in accordance with an illustrative embodiment.

### DETAILED DESCRIPTION

Any item that can be retailed, whether a good or a service, is collectively referred to as a product within the scope of this disclosure.

Presently available buying assistance solutions are limited in many ways in how they assist the customer through the buying decision making process. Generally, the presently available solutions rely on static sets of rules to assist a customer with product selection. For example, some presently available solutions offer a customer only those product choices that are manufactured or retailed by the particular manufacturer or retailer who is offering the solution. Some other solutions suggest products from different manufacturers or retailers but only according to the customer's expressly specified criteria.

Some other solutions suggest what other customers with similar needs are buying. Certain solutions suggest additional products that may be useful with the product the customer has either already selected or is currently considering. Some solutions suggest what product selections might exist just outside the customer's expressly selected criteria.

The illustrative embodiments recognize that the decision process behind buying a product involves not only the characteristics of the product but also the preferences of the customer. The illustrative embodiments further recognize that a product, or a class or category of products (product class), has certain attributes that are descriptive of certain corresponding aspects of the product or product class.

For example, a particular make and model of an automobile is a product belonging to the product class “automobile.” The product class “automobile” has certain aspects that are common to all specific automobile products within the class. A particular product, such as a particular make and model of the automobile has aspects that are descriptive of the particular product. For example, the automobile product class has an attribute “color.” A particular car has attribute “color” with a value “red” for that attribute. Similarly, the automobile class may have an attribute “price-range” and a particular car may have an attribute “price” for the given make and model.

The illustrative embodiments recognize that the customer's buying decision is also affected by social, economical, demographical, cultural, and personal preferences or choices of the customer (collectively referred to as customer's buying behavior factors). The illustrative embodiments recognize that certain logical conclusions can be derived from such customer buying behavior factors to guide the buying decision when this example customer expresses an interest in buying a car. The illustrative embodiments further recognize that the combination of product attributes and customer buying behavior factors can be analyzed to assist the customer in the buying process.

The illustrative embodiments used to describe the invention generally address and solve the above-described problems and other problems related to the decision making process behind a buying decision. The illustrative embodiments provide a method, system, and computer program product for assisting buying decisions using customer behavior analysis.

An embodiment collects customer behavior information from a variety of sources. For example, social media websites and portals provide information that provides insight into how a customer thinks generally about a variety of topics. For example, a customer's social circle has an influence on the customer's buying decision. Knowing who the customer's influencers are also reveals what their influence on the customer's buying decision might be.

The customer's expressed thoughts or opinions about things and events lend insight into what characteristics align with the customer's thinking. For example, a customer who cannot comment enough about the high-school days is probably not too long out of high-school, fascinated by things of shape or style of an era, or is attracted to things that were preferred during a period. As another example, a customer who has a hobby about fast cars will have a different buying preference than another who likes things as they appear in nature. Other conclusions can be similarly drawn from customer behavior information collected from a variety of sources.

As another example, a customer whose customer behavior information reveals that he is a reader of technology magazines, of European descent, dislike red color, in a middle class income bracket, and with three children and a mortgage, may prefer a European sedan in a certain color. Browsing history of a customer's browser also informs about the customer's behavior by revealing the customer's likings and dislikes, for example, based on time spent on a website, navigation into websites, navigating away from certain content, and other such activities.

The illustrative embodiments are described with respect to certain data processing systems, environments, items, products, components, and applications only as examples. Any specific manifestations of such artifacts are not intended to be limiting to the invention. Any suitable manifestation of data processing systems, environments, items, products, components, and applications can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

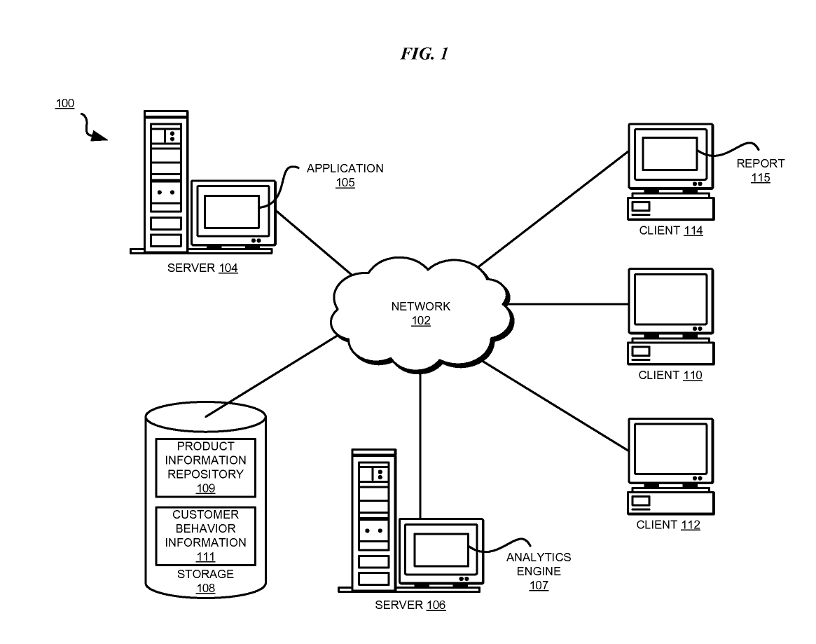

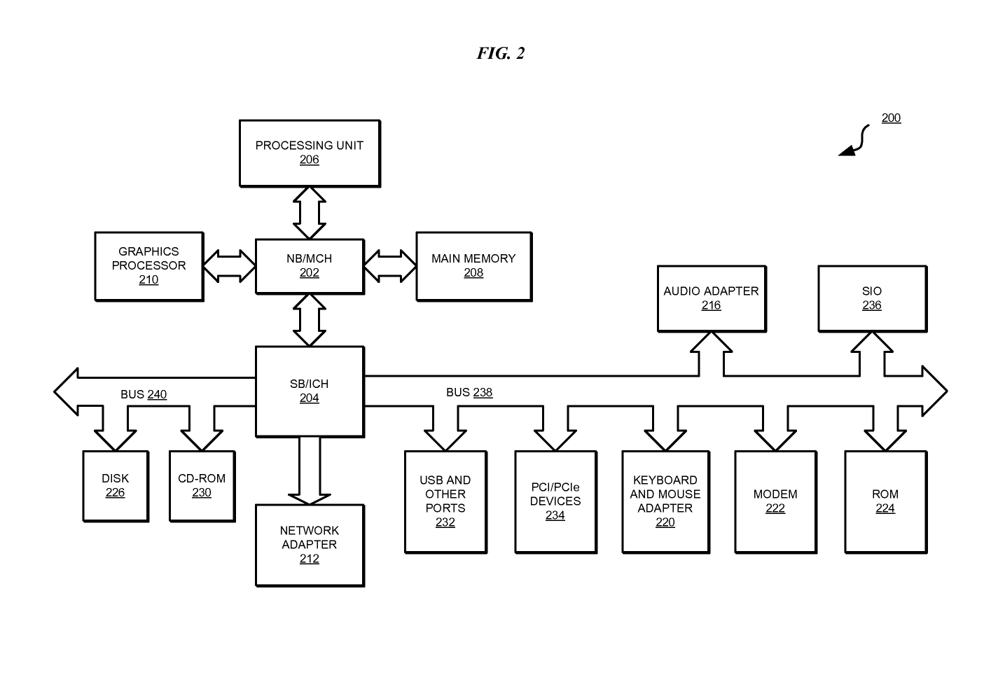

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are useable in an embodiment. For example, Application 105 in server 104 implements an embodiment for assisting buying decisions using customer behavior analysis described herein. Analytics engine 107 in server 106 implements a combination of analytical tools and techniques to be used within or in conjunction with application 105 as described herein. Product information repository 109 in storage 108 stores product information, including but not limited to product or product class ontologies or taxonomies. In one embodiment, product information repository 109 is populated using data sources from the manufacturers, retailers, industry participants, and data sources generally available for information about the products or product classes in question. Customer behavior information 111 in storage 108 stores structured and unstructured information about a customer's behavior and thoughts collected from any number or type of sources, including but not limited to those sources that are described in the examples herein. Report 115 in client 114 is a buying recommendation including one or more products or product classes. In one embodiment, report 115 includes weighted scores of the recommended products or product classes according to the customer's buying behavior factors extracted from customer's behavior information. For example, the recommended product may be prioritized over other products in report 115.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, analytics engine 107 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

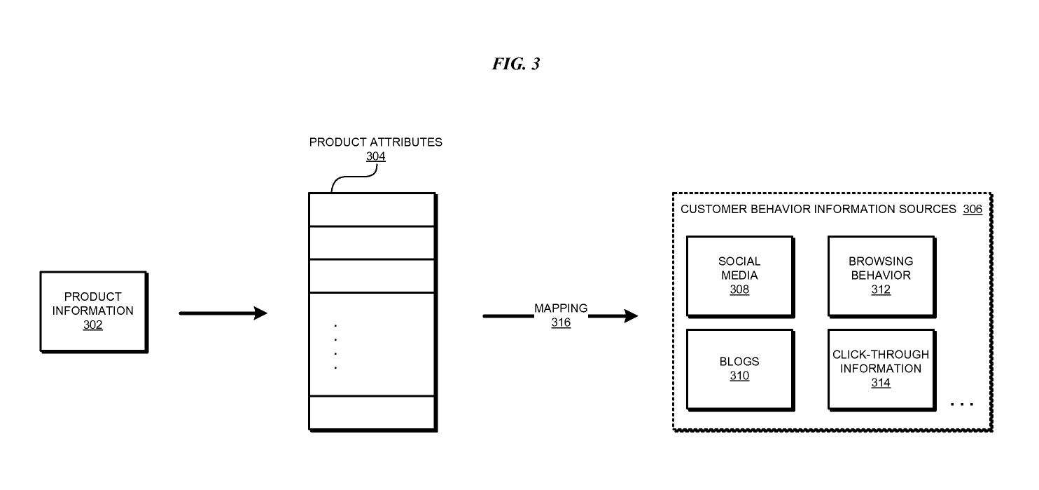

With reference to FIG. 3, this figure depicts a block diagram of a process of correlating product information with customer behavior information in accordance with an illustrative embodiment. References to product and product-related features are used only as examples for clarity and not intended to exclude corresponding operations of an embodiment on product classes.

Product information 302 is stored in product information repository 109 in FIG. 1. Product attributes 304 are extracted, such as from an ontology corresponding to the product of product information 302. Product attributes 304 are a subset of attributes that may be available in such ontology.

An embodiment, such as application 105 in FIG. 1 using analytics engine 107 in FIG. 1, selects the subset based on the customer buying behavior factors identified from customer behavior information obtained from customer behavior information sources 306. For example, social media 308, blogs 310, browsing behavior information 312, and click-through and/or click-stream information 314 from search engines may be some of sources 306. Click-through is a process of a user clicking on a web advertisement and landing at the advertiser's website. Click-stream is the mouse-click data collected during a browsing session. Using a combination of these sources, application 105 identifies a set of customer buying behavior factors. In one example operation using the example customer of European descent who is shopping for a car, application 105 determines that the customer has positive and negative preferences. For example application 105 determines that When considering vehicles, the customer tends to discuss his experiences from the nineties decade, his old reliable sedan that he modified with new gadgets, the ticket he got one time driving the red rental car, and that he now travels regularly with his mid-sized family. Accordingly, application 105 determines that the customer prefers things that have styling from the nineties, not red in color, technologically advanced, and of European origin.

The styling, the color, Country of design or origin, and technical reviews are some customer buying behavior factors that application 105 extracts from the example customer behavior information from sources 306. Application 105 selects those product attributes from a product ontology that correspond to the extracted customer buying behavior factors. The selected product attributes form the subset that is product attributes 304. Application 105 maps product attributes 304 to the extracted customer buying behavior factors using mapping 316.

The example profile of the customer, the example customer behavior information, the example customer buying behavior factors, and the example manner of their extraction are not intended to be limiting on the illustrative embodiments. Those of ordinary skill in the art will be able to use additional or different customer behavior sources for additional or different customer behavior information, from which additional or different customer buying behavior factors can be extracted in a similar manner. Such additional or different data and operations are contemplated within the scope of the illustrative embodiments.

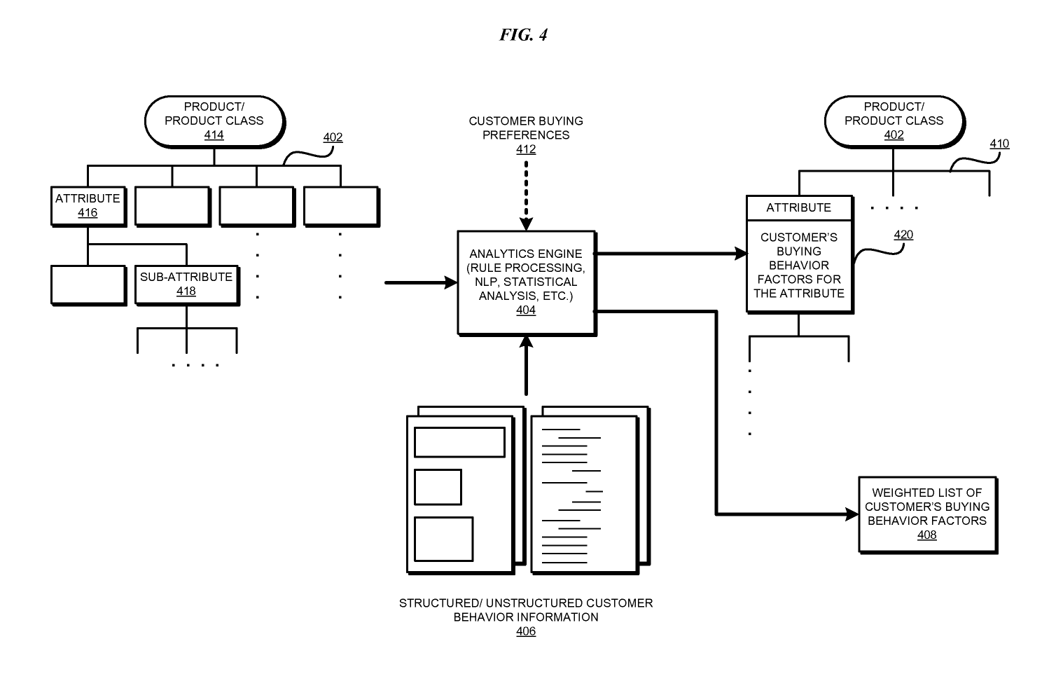

With reference to FIG. 4, this figure depicts a block diagram of an example process of correlating product attributes with customer buying behavior factors for assisting buying decisions using customer behavior analysis in accordance with an illustrative embodiment. Ontology 402 provides product information 302 in FIG. 3. Analytics engine 404 is an example of analytics engine 107 in FIG. 1. Structured and/or unstructured customer behavior information 406 is an example of customer behavior information collected from sources 306 in FIG. 3.

In operation, analytics engine 404 extracts customer buying behavior factors 408. Customer buying behavior factors 408 are weighted. Analytics engine 404 assigns weights to various customer buying behavior factors in customer buying behavior factors 408 to further clarify which factors appear to be more useful to or preferred by the customer.

In one embodiment, customer's buying preferences 412 for the product or product class may also be known, as in the prior art. Analytics engine 404 can also take preferences 412 into account when extracting the customer buying behavior factors from information 408.

Analytics engine 404 outputs subset 410 of product attributes that is mapped to weighted customer buying behavior factors 408. Subset 410 can be presented in any suitable manner. In one embodiment, subset 410 is organized (shown) in a similar manner as ontology 402. In another embodiment, subset 410 is organized (not shown) in a tabular form with matching products, matching customer buying behavior factors or both.

As an example, ontology 402 is depicted as a tree of attributes and sub-attributes associated with a product or product class. For example, assume that ontology 402 is an ontology for product 414. Ontology 402 includes attribute 416 as one of several attributes of product 414. Attribute 416, in turn, includes one or more sub-attributes, such as sub-attribute 418.

Assume that analytics engine 404 finds a customer buying behavior factor in customer buying behavior factors 408 that corresponds to attribute 416. Analytics engine 404 maps the customer buying behavior factor to attribute 416 and outputs mapping 420 as a part of subset 410.

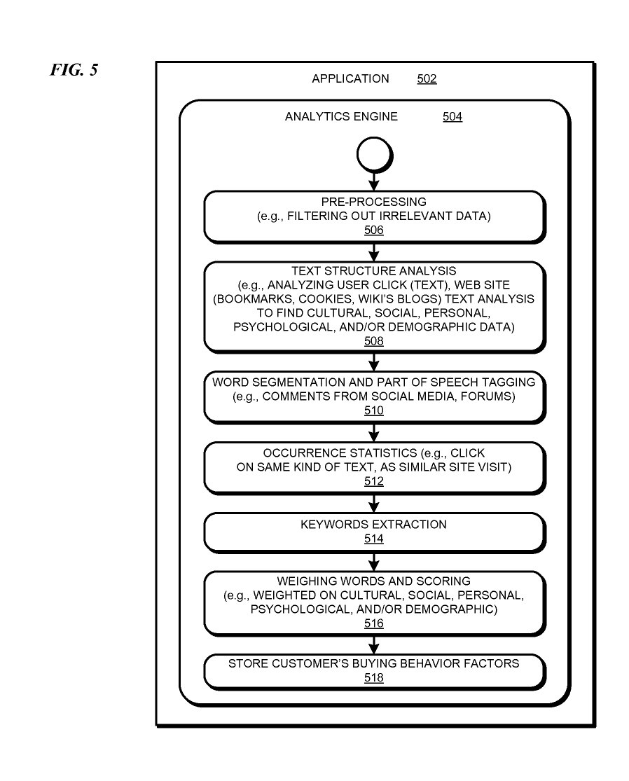

With reference to FIG. 5, this figure depicts a block diagram of an example configuration of an analytics engine in accordance with an illustrative embodiment. Application 502 is an example embodiment of application 105 in FIG. 1 and uses analytics engine 504. Analytics engine 504 can be used as analytics engine 404 in FIG. 4.

Analytics engine 504 operates by using a combination of rules processing techniques, natural language processing, statistical analysis, and other tools and techniques. For example, in one embodiment, analytics engine 504 pre-processes 506 customer behavior information 406 in FIG. 4 to filter out data that, according to a rule, is irrelevant to the product, product class, or the buying decision in question.

In one embodiment, analytics engine 504 performs structure analysis 508 of customer behavior information, such as to perform an analysis of the mouse-clicks made by the customer on certain websites or the bookmarks saved or visited by the customer. When needed in an embodiment, analytics engine 504 also performs, as a part of structural analysis 508, parsing, keyword searches, natural language processing of text, speech, graphic, or video information collected from sources 306 in FIG. 3.

In an embodiment, analytics engine 504 performs word segmentation and speech tagging 510, such as on textual or speech comments on social media websites. As needed in an embodiment, analytics engine 504 uses statistical analysis tools to determine occurrence statistics 512 in the customer behavior information. For example, analytics engine 504 may determine a number of times the customer visited a particular website, a number of times the customer made cultural references, or the number of occurrences of a particular influencer's comments on a subject related to the product or the buying decision. Similarly, analytics engine 504 can also perform keyword extraction 514 using subject-matter domain related lexicons, cultural knowledgebases, occurrence-based keyword identification, machine learning based keyword search algorithms, and so on.

The above described example techniques, and other similarly purposed techniques allow the analytics engine to identify what is important to the customer according to the customer's thought process. The extracted keywords, phrases, speech tags, textual or graphical structures and information, or other similar artifacts form customer buying behavior factors 408 in FIG. 4.

In one embodiment, analytics engine 504 further performs weighting 516 of customer buying behavior factors 408. For example, analytics engine 504 can weight a keyword based on number of occurrences, occurrence in a context that appears to be of importance to the customer, such as due to comparative volume of customer behavior data in that context. Some example contexts can be cultural, social, personal, psychological, economical, familial, demographic, professional, political, technical, and so on. For example, if the technical context appears to be more prevalent in customer behavior information 408 than political context, and a keyword “power” appears four times in each context, when the buying decision is about a car, the customer buying behavior factor “power” is assigned a higher weight than, for example, price.

Analytics engine 504 stores 518 the customer buying behavior factors extracted in manner described above using a combination of the above-described and other comparable techniques. The example techniques for customer buying behavior factor extraction described herein are not intended to be limiting on the illustrative embodiments. Those of ordinary skill in the art will be able to conceive other techniques for customer buying behavior factor extraction from customer behavior information 408 and the same are contemplated within the scope of the illustrative embodiments.

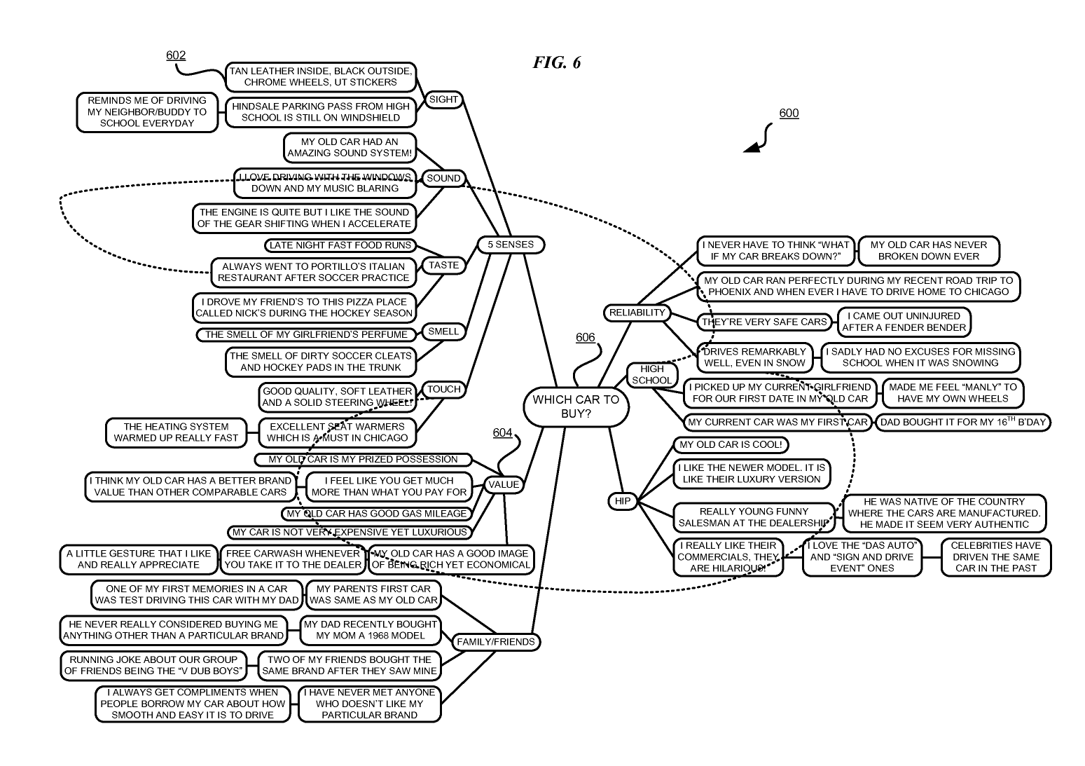

With reference to FIG. 6, this figure depicts a graph chart of extracting customer buying behavior factors from customer behavior information for assisting buying decisions using customer behavior analysis in accordance with an illustrative embodiment. Graph 600 is depicted to include social media interactions only as an example without implying a limitation on the illustrative embodiments thereto. Information 602 is an example of a message in a social media conversation posted by the customer. Factor 604 is an example customer buying behavior factor extracted from analyzing a collection of information similar to information 602 in graph 600. Factor 604 and other similarly extracted customer buying behavior factors are relevant to the buying decision 606-“which car to buy?” Accordingly, as described with respect to FIGS. 4 and 5, analytics engine 404 in FIG. 4 associates or maps factor 604 and other similarly extracted factors to attributes of a particular automobile product or the product class “automobile” to present the customer with some purchase selections that take into account the customer's behavior, thought process, and inherent unexpressed preferences. An inherent unexpressed preference is a preference that the customer has not overtly expressed in any manner, but which the customer covertly, implicitly, inherently, or subconsciously incorporates into a selection process when making a selection.

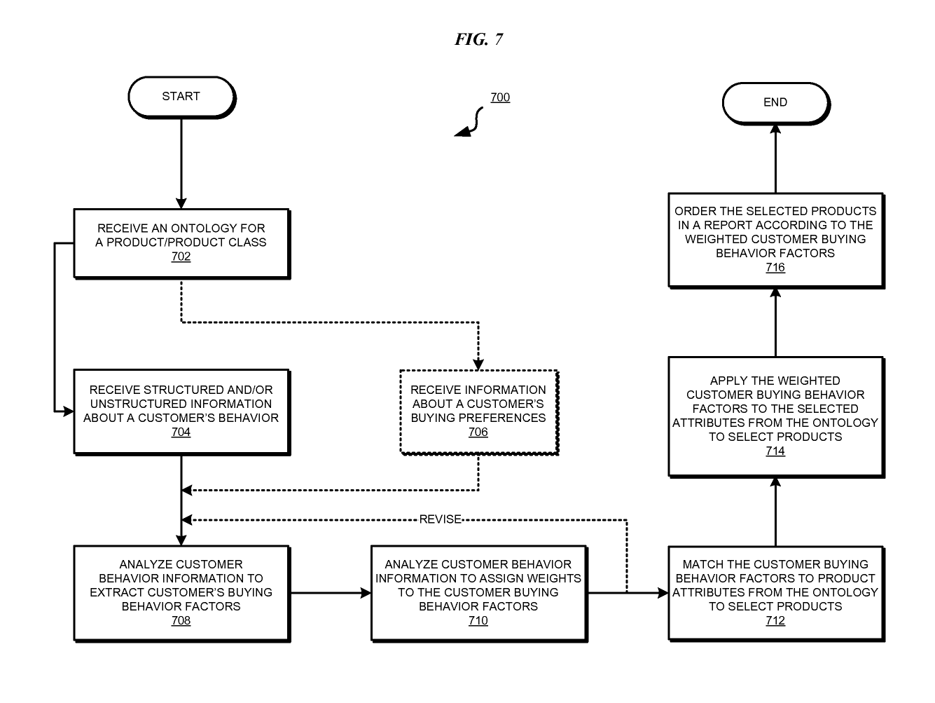

With reference to FIG. 7 this figure depicts a flowchart of an example process for assisting buying decisions using customer behavior analysis in accordance with an illustrative embodiment. Process 700 can be implemented in application 502 using analytics engine 504 in FIG. 5.

The application, according to an embodiment, begins by receiving an ontology for a product or a product class (step 702). The application receives structured data, unstructured data, or a combination thereof, as customer's behavior information (step 704). Optionally, the application may also receive information about the customer's expressed buying preferences, if available, as a part of the customer behavior information (step 706).

The application analyzes the customer behavior information to extract a set of customer buying behavior factors (step 708). The application analyzes the customer behavior information to determine and assign weights to the customer buying behavior factors (step 710).

Customer behavior information can change over time. For example, a customer's preferences may change with customer's age, new buying opportunities, new products, advertising and other influences on the customer, and the like. The customer's buying behavior may also change as a result of an overt change in preferences provided by the customer.

In one embodiment, the application initiates steps 708 and 710 with available customer behavior information, and repeat steps 708 and 710 as more or newer customer behavior information becomes available. The re-analysis with additional or newer customer behavior information allows the application to dynamically respond to a variety of buying decisions, at different times, and as the customer's preferences change over time.

The application matches the customer buying behavior factors to a subset of product attributes from the ontology (step 712). For example, in one embodiment, the application determines that a greater than a threshold degree of correspondence exists between a product attribute and a weighted customer buying behavior factor, and selects the product attribute as a member of the subset. In one embodiment, when the ontology is of a product class, the application can select not only the subset of attributes, but also a subset of products within that class whose attributes exhibit a closer correspondence with the customer buying behavior factors than a threshold level of correspondence other products in the class.

The application applies the weighted customer buying behavior factors to the subset of product attributes, of the selected one or more products (step 714). The application orders the selected products in a report according to the weighted customer buying behavior factors and presents the report to the customer for assisting with the buying decision (step 716). Process 700 ends thereafter. In an example embodiment, the application prioritizes the selected product or products over other products in the report. The prioritization can be manifested in any suitable manner, including but not limited to higher weighting, color coding, different font or font-size, animation, links, graphics, icons, videos, associated promotions, and any of the numerous ways an entry can be highlighted in a list of entries.

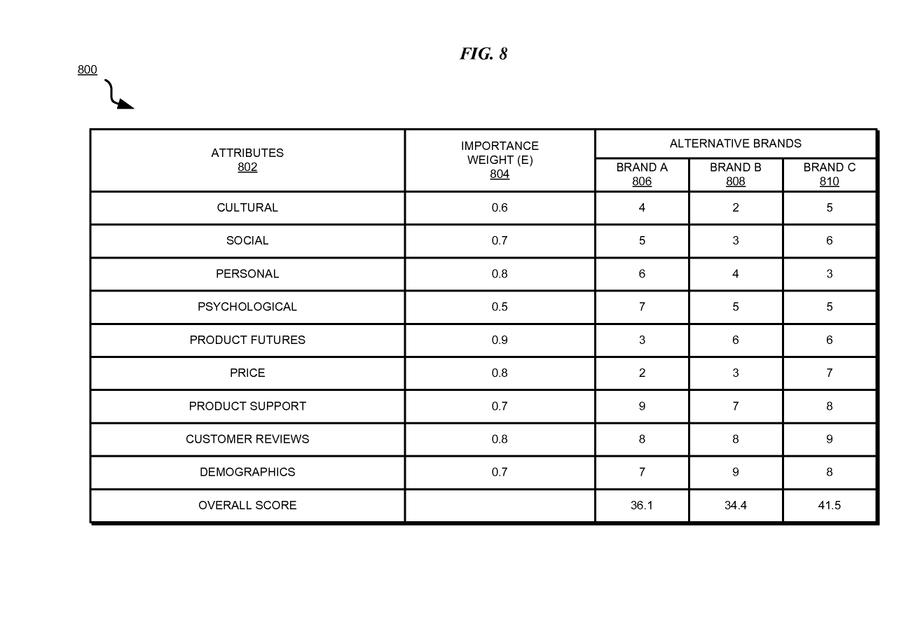

With reference to FIG. 8, this figure depicts an example report generated using an example process for assisting buying decisions using customer behavior analysis in accordance with an illustrative embodiment. Report 800 is an example of a report that can be generated using process 700 in FIG. 7.

Report 800 correlates customer buying behavior factors in column 802 as weighted by their corresponding weights in column 804 with a subset of products attributes of a selected subset of products from a product class. Resulting product selections are depicted in example columns 806, 808, and 810. Report 800 is only an example depiction. Any number of products can be depicted in report 800 in this manner, using any number of customer buying behavior factors in column 802, any manner of weighting in column 804, and correlating to any number and types of product attributes within the scope of the illustrative embodiments.

In one embodiment, if the sum of the weighted customer buying behavior factors as mapped to a product's attributes exceeds a threshold, the product is included in report 800. The sum is designated as the overall score of the product. In the depicted example, report 800 includes three example products whose overall scores exceed a threshold overall score.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for assisting buying decisions using customer behavior analysis. An embodiment provides a solution for assisting a customer's buying decision, in some cases accelerating the decision process by providing the customer with a product ranking and score based on the customer's inherent unexpressed preferences and choice-making thought process.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for assisting buying decisions using customer behavior analysis, the method comprising:
receiving, forming product information, information about a grouping of products, wherein the product information comprises a set of product attributes;
receiving, forming customer behavior information, information about a behavior of a customer;
extracting, using a processor and a memory, from the customer behavior information, a set of customer buying behavior factors, wherein a customer buying behavior factor in the set of customer buying behavior factors comprises an inferred preference of the customer for buying a product from the grouping of products;
assigning, a weight to a customer buying behavior factor in the set of customer buying behavior factors, wherein the weight is a member of a set of weights corresponding to the set of customer buying behavior factors, forming a set of weighted customer buying behavior factors;
mapping the set of weighted customer buying behavior factors to a subset of the product attributes; and
selecting at least one product from the grouping of products such that the at least one product includes a subset of product attributes, and wherein an overall weighted score of the at least one product exceeds a threshold.

2. The method of claim 1, wherein the customer behavior information comprises information from a social media source, wherein the customer contributes data to the social media source in a context unrelated to a buying decision for a product in the grouping of products.

3. The method of claim 1, wherein the customer behavior information comprises a combination of text, graphical, audio, and video data.

4. The method of claim 1, wherein the customer behavior information comprises a combination of demographic information and cultural information about the customer that is contributed by the customer in a context unrelated to a buying decision for a product in the grouping of products.

5. The method of claim 1, further comprising:
counting, in the customer behavior information, occurrences of a keyword corresponding to a product attribute.

6. The method of claim 1, further comprising:
identifying, in the customer behavior information, occurrences of a keyword corresponding to a product attribute in a speech portion of the customer behavior information.

7. The method of claim 1, further comprising:
determining the weight corresponding to a number of occurrences of the customer buying behavior factor in the customer behavior information.

8. The method of claim 1, further comprising:
selecting the subset of product attributes, wherein a member attribute of the subset of product attributes is selected by determining that a greater than threshold degree of correspondence exists between the member attribute and at least one weighted customer buying behavior factor in the set of weighted customer buying behavior factors.

9. The method of claim 1, wherein an attribute in the set of product attributes includes a set of sub-attributes, and wherein the product information comprises an ontology, wherein the set of attributes is organized in a tree graph.

10. The method of claim 1, further comprising:
including the at least one product in a report, wherein the at least one product is prioritized over a second product in the report; and
presenting the report to the customer whereby a buying decision of the customer is assisted by enabling the customer to select the at least one product.

11. A computer program product comprising one or more computer-readable tangible storage devices and computer-readable program instructions which are stored on the one or more storage devices and when executed by one or more processors, perform the method of claim 1.

12. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

13. A computer program product for assisting buying decisions using customer behavior analysis, the computer program product comprising:
one or more computer-readable tangible storage devices;
program instructions, stored on at least one of the one or more storage devices, to receive, forming product information, information about a grouping of products, wherein the product information comprises a set of product attributes;
program instructions, stored on at least one of the one or more storage devices, to receive, forming customer behavior information, information about a behavior of a customer;
program instructions, stored on at least one of the one or more storage devices, to extract, using a processor and a memory, from the customer behavior information, a set of customer buying behavior factors, wherein a customer buying behavior factor in the set of customer buying behavior factors comprises an inferred preference of the customer for buying a product from the grouping of products;
program instructions, stored on at least one of the one or more storage devices, to assign, a weight to a customer buying behavior factor in the set of customer buying behavior factors, wherein the weight is a member of a set of weights corresponding to the set of customer buying behavior factors, forming a set of weighted customer buying behavior factors;
program instructions, stored on at least one of the one or more storage devices, to map the set of weighted customer buying behavior factors to a subset of the product attributes; and
program instructions, stored on at least one of the one or more storage devices, to select at least one product from the grouping of products such that the at least one product includes a subset of product attributes, and wherein an overall weighted score of the at least one product exceeds a threshold.

14. The computer program product of claim 13, wherein the customer behavior information comprises information from a social media source, wherein the customer contributes data to the social media source in a context unrelated to a buying decision for a product in the grouping of products.

15. The computer program product of claim 13, wherein the customer behavior information comprises a combination of text, graphical, audio, and video data.

16. The computer program product of claim 13, wherein the customer behavior information comprises a combination of demographic information and cultural information about the customer that is contributed by the customer in a context unrelated to a buying decision for a product in the grouping of products.

17. The computer program product of claim 13, further comprising:
program instructions, stored on at least one of the one or more storage devices, to count, in the customer behavior information, occurrences of a keyword corresponding to a product attribute.

18. The computer program product of claim 13, further comprising:
program instructions, stored on at least one of the one or more storage devices, to identify, in the customer behavior information, occurrences of a keyword corresponding to a product attribute in a speech portion of the customer behavior information.

19. The computer program product of claim 13, further comprising:
program instructions, stored on at least one of the one or more storage devices, to determine the weight corresponding to a number of occurrences of the customer buying behavior factor in the customer behavior information.

20. A computer system for assisting buying decisions using customer behavior analysis, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to receive, forming product information, information about a grouping of products, wherein the product information comprises a set of product attributes;
program instructions, stored on at least one of the one or more storage devices for execution by at least one of the one or more processors via at least one of the one or more memories, to receive, forming customer behavior information, information about a behavior of a customer;
program instructions, stored on at least one of the one or more storage devices for execution by at least one of the one or more processors via at least one of the one or more memories, to extract, using a processor and a memory, from the customer behavior information, a set of customer buying behavior factors, wherein a customer buying behavior factor in the set of customer buying behavior factors comprises an inferred preference of the customer for buying a product from the grouping of products;
program instructions, stored on at least one of the one or more storage devices for execution by at least one of the one or more processors via at least one of the one or more memories, to assign, a weight to a customer buying behavior factor in the set of customer buying behavior factors, wherein the weight is a member of a set of weights corresponding to the set of customer buying behavior factors, forming a set of weighted customer buying behavior factors;
program instructions, stored on at least one of the one or more storage devices for execution by at least one of the one or more processors via at least one of the one or more memories, to map the set of weighted customer buying behavior factors to a subset of the product attributes; and
program instructions, stored on at least one of the one or more storage devices for execution by at least one of the one or more processors via at least one of the one or more memories, to select at least one product from the grouping of products such that the at least one product includes a subset of product attributes, and wherein an overall weighted score of the at least one product exceeds a threshold.
